(19) United States
(12) Patent Application Publication
(10) Pub. No.: US 2011/0157153 A1
(43) Pub. Date: Jun. 30, 2011

(54) PROJECTION-TYPE IMAGE DISPLAY APPARATUS PROVIDED WITH AN IMAGE PICKUP FUNCTION

(75) Inventors: Kazuo ISHIMOTO, Osaka (JP); Naoyuki Nimura, Osaka (JP); Tatsuya Takahashi, Osaka (JP)

(73) Assignee: SANYO ELECTRIC CO., LTD.

(21) Appl. No.: 12/976,234

(22) Filed: Dec. 22, 2010

(30) Foreign Application Priority Data
Dec. 24, 2009 (JP) 2009-293191

(51) Int. Cl. G06T 1/00

(52) U.S. Cl. 345/418

(57) ABSTRACT

A projection unit projects a predetermined image onto a projection plane through a lens. An image generating unit generates the predetermined image which is to be projected from the projection unit. A code generator generates a notifying image that contains information to be conveyed to another projector provided with an image pickup function. The projection unit projects the notifying image generated by the code generator and has the another projector capture the notifying image so as to convey the information to the another projector.

### CROSS-REFERENCE TO RELATED APPLICATIONS

This application is based upon and claims the benefit of priority from the prior Japanese Patent Application No. 2009-293191, filed on Dec. 24, 2009, the entire contents of which are incorporated herein by reference.

### BACKGROUND OF THE INVENTION

1. Field of the Invention

The present invention relates to a projection-type image display apparatus and, more particularly, to a projection-type image display apparatus provided with an image pickup function.

2. Description of the Related Art

A projection-type image display apparatus (hereinafter referred to as “projector” also) is conventionally used as a projection-type image display apparatus that projects images onto a screen by enlarging the images. A plurality of projectors are used in combination to realize the display of images projected onto a large-sized screen. In such a case, for example, the large screen is constituted by a vertical and horizontal array of a plurality of screens corresponding respectively to the plurality of projectors. Or, for example, the large screen is constituted in a manner such that the images of their respective projectors are arranged and projected onto a single screen using the plurality of projectors. In the former case, each screen is provided with a frame, so that border regions between the screens become unwantedly conspicuous to the eyes of viewers. In the latter case, such a problem of conspicuous frames does not arise.

Where the plurality of projectors are used in combination, there is a strong possibility that the screen is no longer a plane and, therefore, geometrical distortions, color unevenness and shading must be corrected. To cope with this, for example, an image displayed on the screen is picked up by a camera and then the picked-up image data is divided in such a manner that each of the divided data is associated with each projector. Then the each of the divided data is corrected.

A single projector may be used instead of a plurality of projectors used in combination. In such a case, the color tone and/or brightness for projection is set in accordance with the usage. Thus, when the projectors, each of which was used as a stand-alone apparatus, are used in combination, there are cases where the setting of each of such projectors differs. Thus, a user must find a way to adjust the settings so that each projector can be set by the same common operation. To simplify this, an arrangement may possibly be such that the projectors are connected to one another by cables and information on a setting content of the respective projectors (hereinafter this information will be referred to as “set profile”) are exchanged thereamong. However, this arrangement entails an increase in the number of cables as the number of projectors increases, thereby making the whole structure complicated.

### SUMMARY OF THE INVENTION

The present invention has been made in view of the foregoing circumstances, and a purpose thereof is to provide a technology for easily adjusting the setting of each projector when a plurality of projectors are used in combination.

In order to resolve the above problems, a projection-type image display apparatus according to one embodiment of the present invention comprises: a projection unit configured to project a predetermined image onto a projection plane through a lens; and a generator configured to generate the predetermined image which is to be projected from the projection unit. The generator generates a notifying image that contains information to be conveyed to another projection-type image display apparatus provided with an image pickup function, and the projection unit projects the notifying image generated by the generator and has the another projection-type image display apparatus pick up the notifying image, thereby conveying the information to the another projection-type image display apparatus.

Another embodiment of the present invention relates also to a projection-type image display apparatus. This apparatus is a projection-type image display apparatus for projecting a predetermined image onto a projection plane through a lens, and the apparatus comprises: an image pickup unit configured to pick up a notifying image projected by another projection-type image display apparatus, the notifying image containing information to be conveyed from the another projection-type image display apparatus to said projection-type apparatus; and a control unit configured to execute processing in accordance with the information contained in the notifying image picked up by the image pickup unit.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a structure of a projector system according to an exemplary embodiment of the present invention;

FIG. 2 illustrates a structure of a projector of FIG. 1;

FIG. 3 is a sequence diagram showing a display procedure performed by the projector system of FIG. 1; and

FIG. 4 is another sequence diagram showing a display procedure performed by the projector system of FIG. 1.

### DETAILED DESCRIPTION OF THE INVENTION

The invention will now be described by reference to the preferred exemplary embodiments. This does not intend to limit the scope of the present invention, but to exemplify the invention.

An outline of the present invention will be given before a specific description thereof. Exemplary embodiments of the present invention relate to a projector system including a plurality of projectors therein. In the projector system, images projected by the plurality of projectors are combined together, so that a single image is displayed on a screen. As described earlier, each projector may also be independently used as a stand-alone apparatus and therefore the setting suitable for its usage environment is implemented in each projector. If a plurality of such projectors are used in combination, the color tone and brightness will vary from projector to projector and consequently the quality of images displayed by the projection system will degrade. Accordingly, when the projectors are to be used as a projector system, it is desirable that the settings for the respective projectors be unified. In order to carry out such settings with ease, the projector system according to the present exemplary embodiment performs the following processing.

One projector generates an image indicating a set profile (hereinafter this image will be referred to as “code image” also). An example of the code image is a QR code (registered trademark). The projector displays a code image on a screen by projecting the code image thereon. Each of other remaining projectors, equipped with image pickup units, picks up the image of the code image displayed on the screen. These other remaining projectors extract the set profile from the code image and perform the display settings, based on the thus extracted set profile. After the settings have been completed, the other projectors project the images so as to display an image on the screen (hereinafter this displayed image will be referred to as “projection image” also). If there are far too many projectors and some projectors are incapable of picking up the code image, the above-described processing will be repeated. In other words, the projectors, which have executed the display settings based on the set profile, further display the code images on the screen.

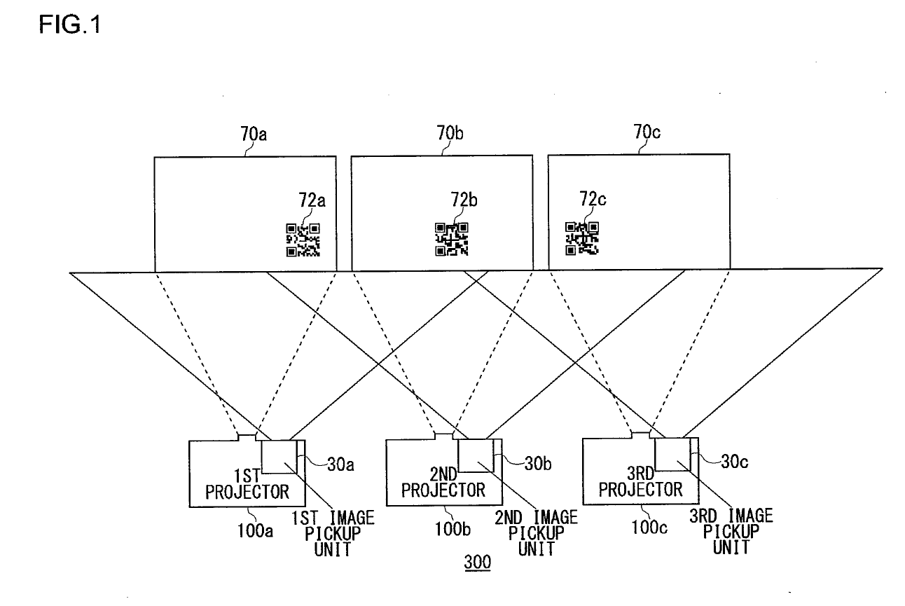

FIG. 1 illustrates a structure of a projector system 300 according to an exemplary embodiment of the present invention. The projector system 300 includes a first projector 100a, a second projector 100b and a third projector 100c, which are generically referred to as “projector 100” or “projectors 100”. The first projector 100a includes a first image pickup unit 30a. The second projector 100b includes a second image pickup unit 30b. The third projector 100c includes a third image pickup unit 30c. Note that the first image pickup unit 30a, the second image pickup unit 30b and the third image pickup unit 30c are generically referred to as “image pickup unit 30” or “image pickup units 30”. The first projector 100a projects a first projection image 70a and a first code image 72a. The second projector 100b projects a second projection image 70b and a second code image 72b. The third projector 100c projects a third projection image 70c and a third code image 72c. Note here that the first projection image 70a, the second projection image 70b and the third projection image 70c are generically referred to as “projection image 70” or “projection images 70”. Note also that the first code image 72a, the second code image 72b and the third code image 72c are generically referred to as “code image 72” or “code images 72”. Each of the first projector 100a to the third projector 100c are a projection-type image display apparatus operable as a stand-alone apparatus. Although the number of projectors 100 used is “3” here, this should not be considered as limiting. For example, the first projector 100a projects the first projection image 70a. The range of projection from the first projector 100a is indicated by the dotted lines in FIG. 1. The second projector 100b and the third projector 100c operate similarly. Thus, the independent setting is done in each of the first projector 100a to the third projector 100c. As discussed earlier, an example of the setting is color tone and brightness. It is assumed herein that the second projector 100b operates as a main projector and the first projector 100a and the third projector 100c operate as subordinate ones.

The second projector 100b generates the second code image 72b based on the set profile. The second projector 100b projects the second code image 72b. The range within which the images can be taken by the first image pickup unit 30a is indicated by the solid lines in FIG. 1. The first image pickup unit 30a picks up the image of the second code image 72b displayed. The first projector 100a extracts the set profile from the thus picked-up second code image 72b. The first projector 100a performs the setting, based on the content of the extracted set profile. As a result, the setting of the second projector 100b and the setting of the first projector 100a are unified. The third projector 100c operates similarly.

In the explanation given so far, it is assumed that the information is conveyed from the main projector to the subordinate ones. If, however, the information is conveyed from a subordinate projector to the main projector, the first projector 100a may generate the first code image 72a based on the information to be conveyed and may project the first code image 72a. The second image pickup unit 30b picks up the image of the first code image 72a, and the second projector 100b obtains information corresponding to the first code image 72a. Note here that the third image pickup unit 30c is incapable of picking up the image of the first code image 72a. Thus, if the information corresponding to the first code image 72a needs to be conveyed to the third projector 100c, the second projector 100b will generate the second code image 72b based on the first code image 72a and then project the thus generated second coded image 72b. When the third image pickup unit 30c picks up the image of the second code image 72b, the third projector 100c obtains the original information. In other words, the second projector 100b performs a relay processing to convey the information from the first projector 100a to the third projector 100c.

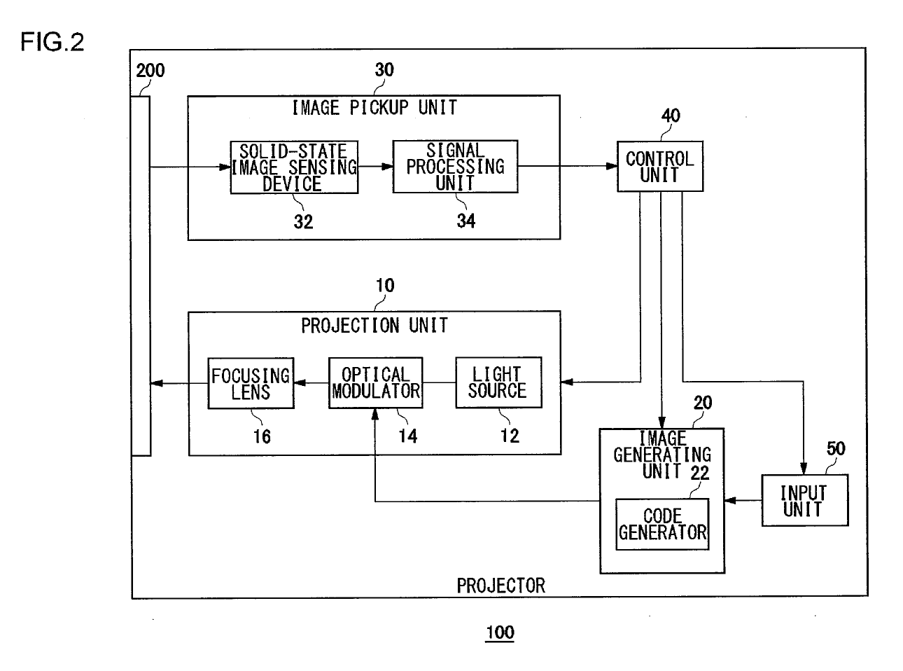

FIG. 2 illustrates a structure of a projector 100. The projector 100 includes a projection unit 10, an image generating unit 20, an image pickup unit 30, a control unit 40, and an input unit 50. The projection unit 10 includes a light source 12, an optical modulator 14, and a focusing lens 16. The image generating unit 20 includes a code generator 22. The image pickup unit 30 includes solid-state image sensing device 32 and a signal processing circuit 34. The projector 100 projects the projection image 70 and the code image 72 of FIG. 1 onto a projection plane 200.

The input unit 50 is connected to a not-shown PC or network, and receives the input of image data to be projected, from the PC or network. The image data is an image or a partial image that constitutes the projection image 70 of FIG. 1. As illustrated in FIG. 1, a single image is formed by a plurality of projection images 70. The image data inputted to the input unit 50 may correspond to the image that constitutes the projection image 70 projected by the projector 100 or may correspond to a partial image of an image projected by the projector system 300. In the former case, the input unit 50 outputs the inputted image data to the image generating unit 20. In the latter case, the input unit 50 extracts a partial image, which the projector 100 is assigned to project, from the inputted image data and then outputs the extracted image data (hereinafter this image will be called “image data” as well) to the image generating unit 20. Note that an instruction as to the partial image to be extracted is given and received from the control unit 40.

The image generating unit 20 receives the image data from the input unit 50. The image generating unit 20 converts the format of the received image data into the format of image data to be projected from the projection unit 10. Known art may be used for the conversion of the image data and therefore the description thereof is omitted here. The image generating unit 20 outputs the converted image data (hereinafter referred to as “image signal”) to the projection unit 10.

The projection unit 10 projects the projection image 70 onto the projection plane 200 such as a screen. Also, the projection unit 10 projects the code image 72 separately from the projection image 70. Note here that the projection unit 10 may project the code image 72 by superimposing the code image 72 onto the projection image 70. A halogen lamp, a metal halide lamp, a xenon short-arc lamp, a high-pressure mercury lamp, an LED lamp or the like is used for the light source 12. The halogen lamp has a filament type electrode structure, and the metal halide lamp has an electrode structure that generates the arc discharge.

The optical modulator 14 modulates light entering from the light source 12 in response to image signals fed from the image generating unit 20. For example, a digital micromirror device (DMD) is used for the optical modulator 14. The DMD, which is equipped with a plurality of miromirrors corresponding to the number of pixels, forms a desired image in such manner that the orientation of each micromirror is controlled according to each pixel signal.

The focusing lens 16 adjusts the focus position of light entering from the optical modulator 14. To adjust the focus position thereof, the lens position is moved on a light axis of the focusing lens 16. Known art may be used for the adjusting of the focus position of light and therefore the description thereof is omitted here. In this manner, the projection unit 10 projects the projection image 70 and the code image 72 on the projection plane 200 through the focusing lens 16.

The control unit 40 controls the entire operation of the projector 100. As described earlier, the control unit 40 manages the setting content as a set profile, and controls the projection unit 10 so that the color tone and the brightness according to the set profile can be achieved. Also, the control unit 40 instructs the input unit 50 about a partial image to be extracted. The set profile may be prepared in advance by the user, for example. If the projector 100 is, for example, the second projector 100b of FIG. 1, the control unit 40 will output the set profile to the code generator 22.

The code generator 22 receives the set profile from the control unit 40. The code generator 22 generates an image signal that constitutes a code image 72 (hereinafter this image signal will be referred to as “code signal” also). Thus, the code signal can be said to contain information to be conveyed to other projectors 100 each provided with an image pickup function. Also, the information may be thought of as information concerning the setting of images 70 projected by the other projectors 100. As described earlier, an example of the code image 72 is the QR code; known art may be employed for the generation of the code signals and therefore the description thereof is omitted here. The code generator 22 outputs the code signal to the projection unit 10.

The projection unit 10 receives the code signal fed from the code generator 22. The projection unit 10 performs the same processing as that performed when the image signal is received, and projects the code image 72. With the code image 72 projected, the projection unit 10 has the other projectors 100 pick up the code image 72 and thereby conveys the information to the other projectors 100. More specifically, the projection unit 10 projects the code image 72 to have the other projectors 100 execute the setting of an image in accordance with the information contained in the code image 72.

In the projectors 100 other than the second projector 100b, each of the image pickup units 30 thereof takes a projection image 70 projected on the projection plane 200. Also, each of the image pickup units 30 picks up the code image 72. That is, the image pickup unit 30 picks up the code image 72 containing the information to be conveyed from the other projectors 100 to its own projection 100 wherein the code 72 is projected by the other projectors 100. As described earlier, the information contained in the code image 72 picked up by the image pickup unit 30 is information on the setting of an image when a predetermined image is projected.

CMOS (Complementary Metal Oxide Semiconductor) image sensors and the like are used as the solid-state image sensing device 32. Also, image pickup devices capable of controlling the shutter timing per scan line using a global shutter method or the like may be used as the solid-state image sensing device 32. The signal processing circuit 34 performs various signal processings, such as A/D conversion, on the signals outputted from the solid-state image sensing device 32, and outputs an image resulting from these processings to the control unit 40. Note here that the image resulting from these processings is hereinafter referred to as “projection image 70” or “code image 72” also)

The control unit 40 receives the projection image 70 or the code image 72 from the signal processing circuit 34. A description is given herein of a case where the code image 72 is received. The control unit 40 extracts the set profile by decrypting the code image 72. Known art may be used to decrypt the code image 72 and therefore the description thereof is omitted here. The control unit 40 performs a processing according to the set profile. More specifically, the control unit 40 performs the setting of an image to be projected. For example, the control unit 40 sets the color tone and brightness indicated by the set profile, to the projection unit 10. Note that the setting performed by the control unit 40 is not limited thereto.

Further, the control unit 40 may output the set profile to the code generator 22. In such a case, as described earlier, the code generator 22 may generate a code signal based on the set profile. A signal such as the code signal may be said to be an image that contains additional information to be conveyed to other projectors 100 in the formation contained in the code image 72 picked up by the image pickup unit 30. In other words, the signal such as the code signal is an image used to relay the content of the set profile.

These above-described structural components may be implemented hardwarewise by a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

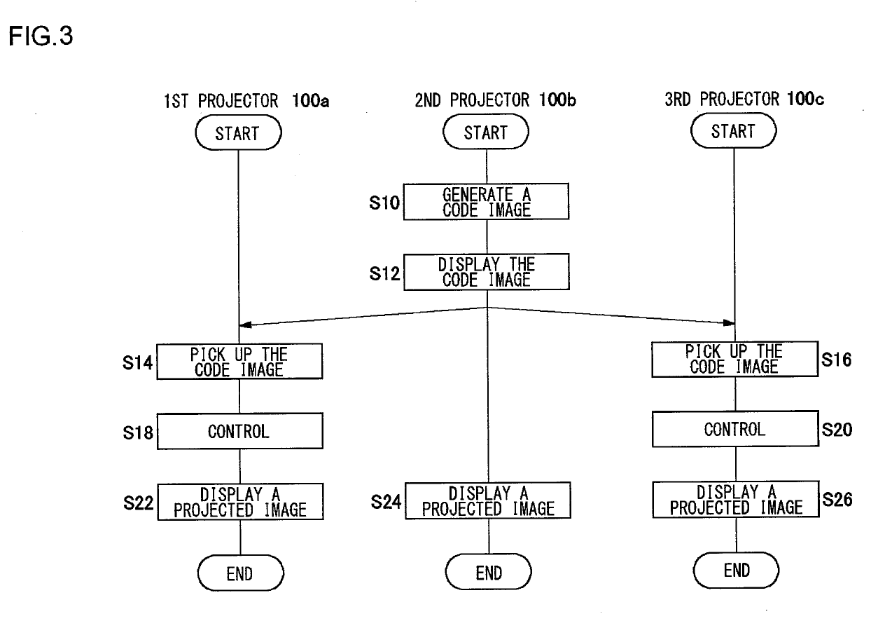

A description is now given of an operational overview of the projector system 300. FIG. 3 is a sequence diagram showing a display procedure performed by the projector system 300. The second projector 100b generates a code image 72 based on the code signal (S10) and displays the code image 72 (S12). The first projector 100a and the third projector 100c each picks up (captures) the code image 72 (S14 and S16). The first projector 100a and the third projector 100c control the display setting of a projection image 70 (S18 and S20). The first projector 100a, the second projector 100b and the third projector 100c each displays the projection image 70 (S22, S24 and S26).

In the above description, only one of projectors 100 generates the code image 72 based on the set profile, and the other remaining projectors 100 control the display, based on the set profile corresponding to the thus generated code image 72. In other words, an absolute setting content is conveyed from the main projector 100 to the subordinate projectors 100. As a modification different from the above arrangement, a “relative” setting content may be conveyed from the main projector 100 to the subordinate projectors 100. The “relative” setting content corresponds to a content that contains variations of or a degree of variation relative to the present setting. For example, the relative setting content contains a brightness level incremented by “1” relative to the present brightness.

Such a processing as described above is advantageous in a case where the type of the main projector 100 differs from that of the subordinate projectors 100. That is, the subordinate projectors 100 convey not only the present set profile itself but also information by which to identify the type of the subordinate projectors 100 (hereinafter this information will be referred to as “identification information”). The code image 72 is also used to convey such additional pieces of information. The image pickup unit 30 in the main projector 100 obtains the code image 72 by taking the image thereof. The control unit 40 in the main projector 100 stores beforehand the correspondence between the set content for the main projector 100 itself and the set contents for the subordinate projectors 100. This correspondence therebetween is stored for each equipment model of the projectors 100.

The control unit 40 extracts the set profiles of the subordinate projectors 100 and their identification information, based on the code image 72. The control unit 40 identifies a specific correspondence to be used, based on the identification information, and then converts the set profiles using the thus identified correspondence. The control unit 40 derives a difference required for a process of changing each converted set profile into a desired set profile. The code generator 22 generates a code signal based on the difference derived. The projection unit 10 projects a code image 72 associated with the code signal. Such a main projector 100 stores the correspondence and derives the difference by converting the set profile, thereby generating the code image 72 based on the difference. As a result, the subordinate projectors 100 are used smoothly in the projector system 300, irrespective of whether the equipment model or type of the subordinate projectors 100 matches that of the main projector 100 or not.

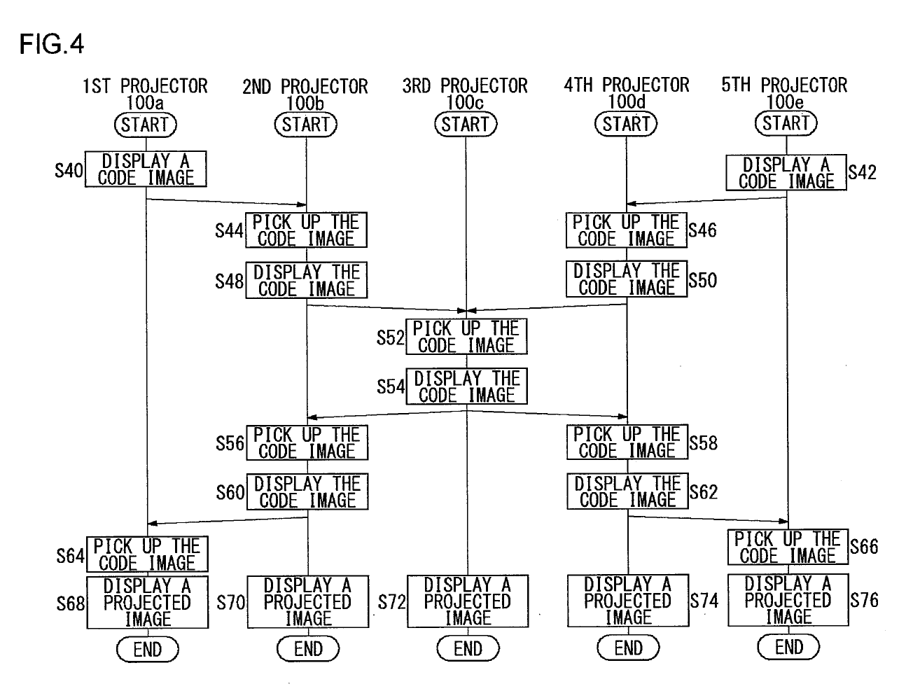

FIG. 4 is another sequence diagram showing a display procedure performed by the projector system 300. Assume in FIG. 4 that the third projector 100c is the main projector 100. The first projector 100a and the fifth projector 100e each displays a set profile and a code image 72 reflecting the identification information (S40 and S42). The second projector 100b and the fourth projector 100d each captures the code image 72 (S44 and S46). The second projector 100b and the fourth projector 100d each displays the code image 72 (S48 and S50). At this time, the second projector 100b generates the code image 72 in such a manner that the set profile and the identification information for the first projector 100a are reflected in addition to the set profile and the identification information for the second projector 100b itself. Similarly, the fourth projector 100d generates the code image 72.

The third projector 100c captures the code image 72 (S52). The third projector 100c generates the code image 72 by reflecting the difference for each projector 100. Thus, the difference for each projector 100 is superimposed on the code image 72. The third projector 100c displays the code image 72 (S54). The second projector 100b and the fourth projector 100d each captures the code image 72 (S56 and S58). Of the information contained in the code image 72, the second projector 100b and the fourth projector 100d obtain partial information thereof strictly concerning their own projectors 100b and 100d, and control the display setting of the code image 72. The second projector 100b and the fourth projector 100d each displays the code image 72 (S60 and S62).

The first projector 100a and the fifth projector 100e each captures the code image 72 (S64 and S66). Of the information contained in the code image 72, the first projector 100a and the fifth projector 100e obtain partial information thereof strictly concerning their own projectors 100a and 100e, and control the display setting of the code image 72. The first projector 100a, the second projector 100b, the third projector 100c, the fourth projector 100d and the fifth projector 100e each displays a projection image 70 (S68, S70, S72, S74 and S76).

By employing the present exemplary embodiment, information which is to be conveyed to other projectors is projected in a manner such that said information is contained in the code image, so that the information can be conveyed to the other projectors without the use of cables otherwise required to connect them. Since the cable connection is no longer required, the procedure taken by the user can be simplified. Also, since the cable connection is no longer required, the complexity involving the cables can be eliminated. Also, since a separate communication device otherwise required to transmit the information is no longer necessary, the structure as a whole system can be simplified. Also, since the structure is simplified, the manufacturing cost can be reduced. Also, since the information on the setting of a projection image is transmitted, the set profile can be conveyed to the other projectors. Also, since the set profile is conveyed, the other projectors can make use of the setting on the display of the image.

Also, the code image is captured and the display of the projection image is set according to the set profile contained in the captured code image. Thus, the settings performed by the other projectors can be utilized. Since the settings performed by the other projectors are utilized, the brightness level and the like of projection images projected by a plurality of projectors can be put to a common use. Also, the brightness level and the like of projection images projected by a plurality of projectors are shared commonly, a degradation in the quality of display of the projection images can be suppressed even when a plurality of projectors are used. Also, the code image is generated, based on the information contained in the captured code image, and then projected. Thus, the information can be passed along from one projector to another in a consecutive manner among the plurality of projectors.

The present invention has been described based on the exemplary embodiments. The exemplary embodiments are intended to be illustrative only, and it is understood by those skilled in the art that various modifications to constituting elements and processes as well as arbitrary combinations thereof could be developed and that such modifications and combinations are also within the scope of the present invention.

In the present exemplary embodiments, the projection unit 10 projects the code image 72. For example, in a modification, the projection unit 10 may project the code image 72 such that the display position of the code image 72 in the projection plane 200 changes with time. More specifically, the projection unit 10 projects the code image 72, with predetermined timing, in an upper left part of the projection image 70 displayed (hereinafter the position in which the projection image 70 is displayed will be referred to as “display area”). At the next timing, the projection unit 10 projects the code image 72 in a lower left part of the display area. Further, the projection unit 10 displays the code image 72, at predetermined intervals, by switching the position, in which the code image 72 is projected, to a lower right part, an upper right part, an upper left part and then back to the lower left part of the display area.

Generally, a lens or a group of lenses whose image capture range is comparatively narrow is used in order to reduce the manufacturing cost of the image pickup units 30. Thus, there is a possibility that code image(s) 72 is/are not captured depending on a display position in which the code image(s) 72 projected by the other projectors 100 is/are displayed. Also, the position where the projector 100 is installed to capture the code image 72 is restricted. As a result, the user gets involved in a complicated process. On the other hand, when the display position of the code image 72 is varied, it is highly probable that the code image 72 is captured at any one of the display positions even though the lens or group of lenses whose image capture range is narrow is used. Also, since it is highly probable that it is captured at any one of the display positions, the restriction imposed on the position where the projectors 100 are installed can be relaxed.

According to the exemplary embodiments of the present invention, the projection unit 10 performs a predetermined processing on the code signal received from the code generator 22, and projects the code image 72. Also, the QR code is exemplified as the code image 72, and the QR code is projected onto a partial part of the display area. However, this should not be considered as limiting and, for example, the code image 72 may be projected in the following three modes (1) to (3).

(1) The code image 72 may be a colored image. In such a case, R, G and B are each information of L bits, and the combination of each bit in R, G and B is associated with a predetermined set profile. By employing this modification, the amount of information transferable by the code image 72 can increase.

(2) The code image 72 may be varied along the time axis, so that the set profile may be also associated with the time axis direction. By employing this modification, a reduction in the amount of transferable information can be suppressed by utilizing the time axis even through the size of the code image 72 itself is small.

(3) The code image 72 may be displayed, in N×M dots, on the entire display area. This modification increases the possibility that the code image 72 can be captured by other projectors 100.

While the preferred exemplary embodiments of the present invention and their modifications have been described using specific terms, such description is for illustrative purposes only, and it is to be understood that changes and variations may be further made without departing from the spirit or scope of the appended claims.

What is claimed is:

1. A projection-type image display apparatus, comprising:
a projection unit configured to project a predetermined image onto a projection plane through a lens; and
a generator configured to generate the predetermined image which is to be projected from said projection unit,
wherein said generator generates a notifying image that contains information to be conveyed to another projection-type image display apparatus provided with an image pickup function, and
wherein said projection unit projects the notifying image generated by said generator and has the another projection-type image display apparatus pick up the notifying image, thereby conveying the information to the another projection-type image display apparatus.

2. A projection-type image display apparatus according to claim 1, wherein the information contained in the notifying image generated by said generator is information on the setting of an image projected by the another projection-type image display apparatus, and
wherein said generator projects the notifying image to have the another projection-type image display apparatus execute the setting of an image in accordance with the information contained in the notifying image generated by said generator.

3. A projection-type image display apparatus according to claim 1, wherein said projection unit projects the notifying image in such a manner that a display position of the notifying image on the projection plane varies with time.

4. A projection-type image display apparatus for projecting a predetermined image onto a projection plane through a lens, the apparatus comprising:
an image pickup unit configured to pick up a notifying image projected by another projection-type image display apparatus, the notifying image containing information to be conveyed from the another projection-type image display apparatus to said projection-type apparatus; and
a control unit configured to execute processing in accordance with the information contained in the notifying image picked up by said image pickup unit.

5. A projection-type image display apparatus according to claim 4, wherein the information contained in the notifying mage picked up by said image pickup unit is information on the setting of an image when the predetermined image is projected, and
wherein said control unit executes the setting of an image in accordance with the information contained in the notifying image picked up by said image pickup unit.

6. A projection-type image display apparatus according to claim 4, further comprising a generator configured to generate a notifying image in the information contained in the notifying image picked up by said image pickup unit, the notifying image containing information to be conveyed to still another projection-type image display apparatus provided with an image pickup function,
wherein said generator has the notifying image projected.
